(19) United States
(12) Patent Application Publication
(10) Pub. No.: US 2005/0190691 A1
(43) Pub. Date: Sep. 1, 2005

(54) High-frequency switch apparatus

(76) Inventors: Toshiki Seshita, Kawasaki-shi (JP); Yoshitomo Sagae, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/845,111

(22) Filed: May 14, 2004

(30) Foreign Application Priority Data
Feb. 27, 2004 (JP) 2004-054909

(51) Int. Cl. H04L 12/26

(52) U.S. Cl. 370/217

(57) ABSTRACT

A high-frequency switch apparatus includes a switch circuit, a terminal and a logical inversion circuit. The switch circuit includes a first FET which has a first threshold voltage and makes a path of a transmission signal conductive or cut off and a second FET which makes a path of a reception signal conductive or cut off. It switches between transmission and reception modes. The terminal is connected to the second FET and receives a control signal which switches between the transmission and reception modes. The logical inversion circuit includes third and fourth FETs having a threshold voltage equal to the first threshold voltage and having source electrodes connected to each other. The logical inversion circuit outputs a first voltage equal to a high level of the control signal to a gate electrode of the first FET in the transmission mode.

### CROSS-REFERENCE TO RELATED APPLICATIONS

This application is based upon and claims the benefit of priority from prior Japanese Patent Application No. 2004-054909, filed Feb. 27, 2004, the entire contents of which are incorporated herein by reference.

### BACKGROUND OF THE INVENTION

1. Field of the Invention

The present invention relates to a high-frequency switch apparatus which switches between modes of transmitting and receiving a high-frequency signal, and particularly to an SPDT (single-pole double-through) switch for handling a high-frequency signal.

2. Description of the Related Art

A high-frequency communication apparatus, such as a cellular phone, generally employs an SPDT switch using a semiconductor switch to switch between transmission and reception. The SPDT switch is a high-frequency switch to output a signal received by a single input terminal to either of the output terminals for two signal paths.

FIG. 6 is a circuit diagram showing a conventional SPDT switch. The SPDT switch comprises an antenna terminal ANT, a transmission terminal TX, a reception terminal RX, control terminals CON1 and CON2, a power supply voltage terminal VD and a ground voltage terminal GND. The terminal ANT is connected to an antenna. The terminal TX receives a transmission signal. The terminal RX outputs a reception signal.

A power supply voltage Vdd is applied to the terminal VD. The terminal VD is grounded via a decoupling capacitor Cp. In other words, the terminal VD is grounded so as to let a high-frequency signal flow to the ground, and receive a direct-current (DC) power supply voltage Vdd. The ground voltage is applied to the ground terminal GND.

The SPDT switch comprises a transmission side through FET Q1, a reception side through FET Q2, a transmission side shunt FET Q3, a reception side shunt FET Q4, and five resistors R1, R2, R3, R4 and R5.

The through FET Q1 is connected between the terminal TX and the terminal ANT. The through FET Q2 is connected between the terminal RX and the terminal ANT. The shunt FET Q3 is connected between the terminal TX and the terminal VD. The shunt FET Q4 is connected between the terminal RX and the terminal VD.

A gate electrode of the through FET Q1 is connected to the control terminal CON1 via the resistor R1. A gate electrode of the through FET Q2 is connected to the control terminal CON2 via the resistor R2. A gate electrode of the shunt FET Q3 is connected to the control terminal CON2 via the resistor R3. A gate electrode of the shunt FET Q4 is connected to the control terminal CON1 via the resistor R4. The terminal ANT is connected to the terminal VD via the resistor R5.

The FETs Q1 to Q4 have a negative threshold voltage Vth. The threshold voltage Vth is set to a value between 0 V to −|Vdd|V (for example, Vth=−0.6 V) As shown in FIG. 6, the DC potentials of the source electrodes or drain electrodes of all FETs in the SPDT switch are set to the power supply voltage Vdd.

A control signal Vcon1 is supplied to the control terminal CON1. A control signal Vcon2 is supplied to the control terminal CON2. The control signals Vcon1 and Vcon2 are complementary signals. The control signal Vcon1 or Vcon2 is formed of a high-level signal (e.g., the power supply voltage Vdd) and a low-level signal (e.g., 0 V).

The characteristic required for the FET is that the ON resistance Ron (the value of the resistance between the source and drain in the ON state) is small and the OFF capacitance Coff (the value of the capacitance between the source and drain in the OFF state). An HEMT (high electron mobility transistor), formed of a compound semiconductor compounded from a plurality of elements, is known as an FET having such a characteristic. The HEMT is a field effect transistor utilizing the phenomenon that an electron layer, formed on the interface between two semiconductor layers (e.g., InAlAs and InGaAs) having different band gaps, operates faster than the normal semiconductor). The HEMT satisfies both requirements of the low ON resistance Ron and the low OFF capacitance Coff. Since the HEMT has the excellent characteristic, various high-frequency switches are produced by using HEMTs.

The SPDT switch shown in FIG. 6 requires two control signals complementary to each other in order to switch between transmission and reception. If the SPDT switch incorporates a logical inversion circuit, only one control signal suffices. Conventionally, for example, a source-grounded circuit comprising an enhancement-type FET is used as the logical inversion circuit. In the enhancement-type FET, the high level of the output is the power supply voltage Vdd, while the low level thereof is substantially 0 V if the ON resistance of the source-grounded FET is sufficiently small relative to the load. Thus, the output voltage of the logical inversion circuit is swung almost all over the range of the power supply voltage.

However, when depletion-type FETs having a negative threshold voltage are used as FETs forming the SPDT switch, an enhancement-type FET for a logical inversion circuit must be provided in addition to the FETs forming the main body of the SPDT switch. Since the HEMT is formed on an epitaxial substrate, it is difficult to form FETs of two types having different threshold voltages. Therefore, high manufacturing cost is incurred, and the circuit area of the SPDT switch is increased.

As related art of this type of switch, an SPDT switch that performs a switching operation with a single control voltage input is disclosed (Jpn. Pat. Appln. KOKAI Publication No. 6-85641).

### BRIEF SUMMARY OF THE INVENTION

A high-frequency switch apparatus according to an aspect of the present invention includes a switch circuit, a third terminal and a logical inversion circuit. The switch circuit comprises: a first terminal to which a transmission signal is input; a first FET which has a first threshold voltage and makes a path of the transmission signal conductive or cut off; a second terminal which outputs a reception signal; and a second FET which makes a path of the reception signal conductive or cut off. The switch circuit switches between a transmission mode of inputting and outputting the transmission signal and a reception mode of inputting and outputting the reception signal. The third terminal is connected to a gate electrode of the second FET and receives a control signal which switches between the transmission mode and the reception mode. The logical inversion circuit comprises a differential circuit, an input section connected to the third terminal and an output section connected to a gate electrode of the first FET. The differential circuit includes third and fourth FETs having a threshold voltage substantially equal to the first threshold voltage. Source electrodes of the third and fourth FETs are connected to each other. The logical inversion circuit outputs a first voltage substantially equal to a high level of the control signal in the transmission mode, and a second voltage which turns off the first FET in the reception mode.

### BRIEF DESCRIPTION OF THE SEVERAL VIEWS OF THE DRAWING

FIG. 1 is a circuit diagram showing the structure of an SPDT switch 1 according to a first embodiment of the present invention.

FIG. 2 is a sectional view showing an example of the configuration of an HEMT.

FIG. 3 is a diagram showing the input/output characteristic of a logical inversion circuit 3 shown in FIG. 1.

FIG. 4 is a circuit diagram showing an example of the configuration of a triple gate FET.

FIG. 5 is a circuit diagram showing the structure of an SPDT switch 1 according to a second embodiment of the present invention.

FIG. 6 is a circuit diagram showing an example of the conventional SPDT switch.

### DETAILED DESCRIPTION OF THE INVENTION

Hereinafter, embodiments of the present invention will be described with reference to the accompanying drawings. In the following description, the elements having the same function or structure are identified by the same reference symbol, and repeated explanations will be provided only when necessary.

### First Embodiment

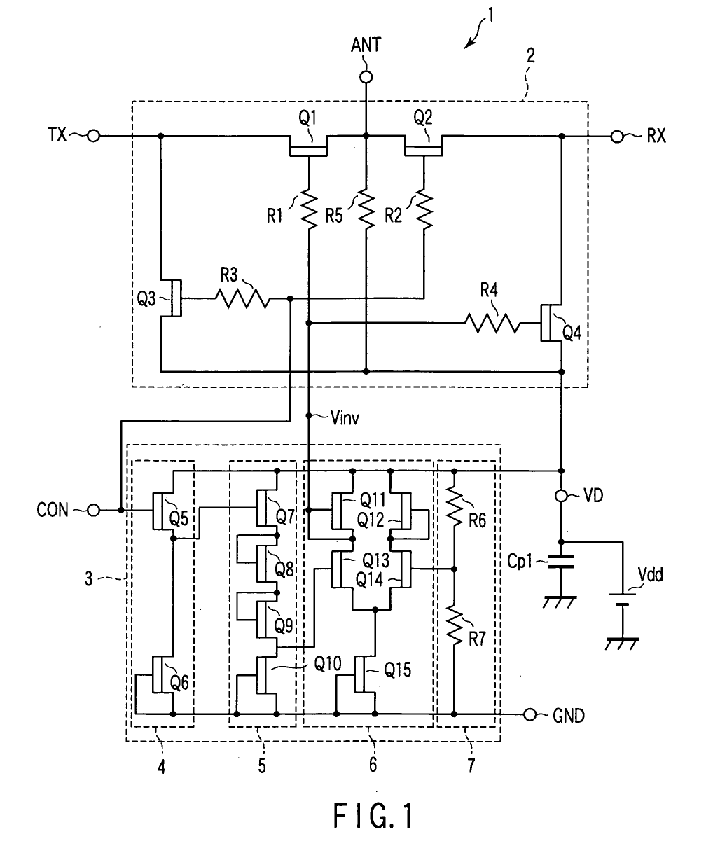

FIG. 1 is a circuit diagram showing the structure of an SPDT switch according to a first embodiment of the present invention. The SPDT switch 1 comprises an antenna terminal ANT, a transmission terminal TX, a reception terminal RX, a control terminal CON, a power supply voltage terminal VD and a ground voltage terminal GND.

The terminal ANT is connected to an antenna. The terminal TX is connected to an output section of a power amplifier (not shown), which amplifies, for example, a transmission signal. The terminal TX receives a transmission signal. The terminal RX is connected to an input section of a transmission side amplifier (not shown), which amplifies, for example, a reception signal. The terminal RX outputs a reception signal.

A power supply voltage Vdd is applied to the terminal VD. The terminal VD is grounded via a decoupling capacitor Cp. In other words, the terminal VD is grounded so as to let a high-frequency signal flow to the ground, and receive a direct-current (DC) power supply voltage Vdd. The ground voltage is applied to the ground terminal GND.

A control signal Vcon to switch between transmission and reception is input to the control terminal CON. The control signal Vcon is formed of a high-level signal (e.g., the power supply voltage Vdd) and a low-level signal (e.g., 0 V).

The SPDT switch 1 comprises a switch circuit 2 and a logical inversion circuit 3. The switch circuit 2 switches between a transmission path and a reception path based on the control signal Vcon, and an inverse signal Vinv, which is output from the logical inversion circuit 3. The logical inversion circuit 3 performs logical inversion of the control signal Vcon and outputs the inverse signal Vinv.

The switch circuit 2 comprises a transmission side through FET Q1, a reception side through FET Q2, a transmission side shunt FET Q3, a reception side shunt FET Q4, and five resistors R1, R2, R3, R4 and R5.

The through FET Q1 is connected between the terminal TX and the terminal ANT. The through FET Q2 is connected between the terminal RX and the terminal ANT. The shunt FET Q3 is connected between the terminal TX and the terminal VD. The shunt FET Q4 is connected between the terminal RX and the terminal VD.

A gate electrode of the through FET Q1 receives the inverse signal Vinv via the resistor R1. A gate electrode of the through FET Q2 is connected to the control terminal CON via the resistor R2. A gate electrode of the shunt FET Q3 is connected to the control terminal CON via the resistor R3. A gate electrode of the shunt FET Q4 receives the inverse signal Vinv via the resistor R4.

The terminal ANT is connected to the terminal VD via the resistor R5. As clear from the interconnection described above, the DC potentials of the source electrodes or drain electrodes of all FETs in the switch circuit 2 are set to the power supply voltage Vdd. The resistors R1 to R5 are used to provide a bias voltage and cuts off a high-frequency signal. The resistors have a high-resistance of, for example, about 10 kΩ.

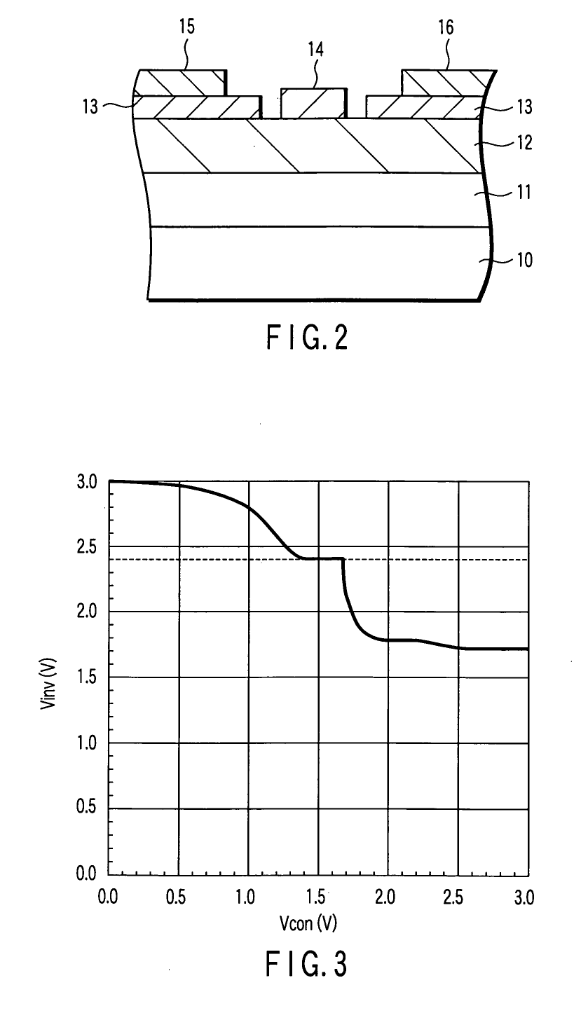

The FETs Q1 to Q4 have a negative threshold voltage Vth. The threshold voltage Vth is set to a value between 0 V to −|Vdd| V (for example, Vth=−0.6 V). The FETs forming the switch circuit 2 are, for example, HEMTs. FIG. 2 is a sectional view showing an example of the configuration of an HEMT.

Referring to FIG. 2, a channel layer 11 (made of InGaAs) is formed on a substrate 10 (made of GaAs). The channel layer 11 is an undoped layer having a low concentration of impurity ions. A carrier supply layer 12 (made of InAlAs) is formed on the channel layer 11. The carrier supply layer 12 is a doped layer having a high concentration of impurity ions. The combination of the channel layer 11 and the carrier supply layer 12 is called a conductive layer.

A gate electrode 14 is formed on the carrier supply layer 12. An ohmic contact layer 13 (made of InAlAs) is formed on the carrier supply layer 12. A source electrode 15 and a drain electrode 16 are formed on the ohmic contact layer 13.

In the HEMT as described above, in the state where carriers (for example, electrons) are traveling, electrons are continuously supplied to the channel layer. In this time, since the impurity ions scattered in the channel layer 11 are reduced, high electron mobility is obtained. Therefore, the HEMT has the characteristics of high electron mobility and high withstand voltage. Further, the HEMT realizes the low ON resistance Ron and the low OFF capacitance Coff.

The logical inversion circuit 3 will now be described. The logical inversion circuit 3 comprises an input buffer circuit 4, a level shift circuit 5, a differential circuit 6 and a reference voltage generating circuit 7. The FETs forming the logical inversion circuit 3 have the same configuration as that of the FETs used in the switch circuit 2.

The input buffer circuit 4 is provided so that substantially no current flows from the control terminal CON to the logical inversion circuit 3, even when the control signal Vcon varies from 0 V to “Vdd” V. The input buffer 4 comprises a FET Q5 and a FET Q6, forming a source follower circuit. The drain electrode of the FET Q5 is connected to the terminal VD. The gate electrode of the FET Q5 is connected to the control terminal CON. The source electrode of the FET Q5 is connected to the drain electrode of the FET Q6. The gate electrode and the source electrode of the FET Q6 are connected to each other. The source electrode of the FET Q6 is connected to the terminal GND. The FET Q6 is used as an active load.

The level shift circuit 5 is provided to shift the level of the control signal Vcon to the negative side, and to apply the voltage of a suitable level to the differential circuit 6 of the next stage. The level shift circuit 5 is formed of a source follower circuit. The level shift circuit 5 comprises FETs Q7 to Q10. The drain electrode of the FET Q7 is connected to the terminal VD. The gate electrode of the FET Q7 is connected to the output section of the input buffer 4 (the source electrode of the FET Q5). The source electrode of the FET Q7 is connected to the drain electrode of the FET Q8.

The drain electrode and the gate electrode of the FET Q8 are diode-connected. The source electrode of the FET Q8 is connected to the drain electrode of the FET Q9. The drain electrode and the gate electrode of the FET Q9 are diode-connected. The source electrode of the FET Q9 is connected to the drain electrode of the FET Q10. The gate electrode and the source electrode of the FET Q10 are connected to each other. The source electrode of the FET Q10 is connected to the terminal GND. The FET Q10 is used as an active load. The level shift circuit 5 outputs a level-shifted signal from the source electrode of the FET Q9.

It is relatively difficult to form an ideal diode on an epitaxial substrate used for forming an HEMT. Therefore, in the level shift circuit 5, the diode-connected FETs Q8 and Q9 are used as level shift means. The voltage for level shift varies depending on the power supply voltage Vdd and the characteristics of the FETs; therefore, it is set in accordance with the circuit design.

In this embodiment, the source follower circuit has the two stages of the input buffer circuit 4 and the level shift circuit 5. However, the source follower circuit may have three or more stages.

The reference voltage generating circuit 7 supplies a reference voltage to the differential circuit 6. The reference voltage varies depending on the power supply voltage Vdd and the characteristics of the differential circuit 6; therefore, it is set in accordance with the circuit design. The reference voltage generating circuit 7 comprises the resistors R6 and R7 connected in series between the terminal VD and the terminal GND. The reference voltage generating circuit 7 outputs a reference voltage from the node between the resistors R6 and R7.

The differential circuit 6 performs a logical conversion of a signal output from the level shift circuit 5. The differential circuit 6 comprises an SCFL (source coupled FET logic) circuit, in which the source electrodes of two FETs are connected in common. The differential circuit 6 comprises FETs Q11 to Q15. The drain electrodes of the FETs Q11 and Q12 are connected to the terminal VD. In each of the FETs Q11 and Q12, the gate electrode and the source electrode are connected to each other.

The gate electrode of the FET Q13 is connected to the output section of the level shift circuit 5. The drain electrode of the FET Q13 is connected to the source electrode of the FET Q11. The gate electrode of the FET Q14 is connected to the output section of the reference voltage generating circuit 7. The drain electrode of the FET Q14 is connected to the source electrode of the FET Q12. The source electrode of the FET Q14 is connected to the source electrode of the FET Q13. The source electrode of the FET Q13 is connected to the drain electrode of the FET Q15. The gate electrode and the source electrode of the FET Q15 are connected to each other. The source electrode of the FET Q15 is connected to the terminal GND. In the differential circuit 6, the FETs Q11, Q12 and Q15 are used as active loads. However, resistors may be used instead.

As described before, the switch circuit 2 and the logic inversion circuit 3 are formed of the FETs of the same structure (in this embodiment, for example, HEMTs). In addition, the switch circuit 2 and the logical inversion circuit 3 are formed on the same substrate.

An operation of the SPDT switch 1 thus constructed will now be described. First, an operation of the switch circuit 2 will be described. It is assumed that, in this embodiment, the threshold voltage Vth of each FET is −0.6 V and the power supply voltage Vdd is 3 V. However, the present invention is not limited to this embodiment.

When the control signal Vcon is of high level and the inverse signal Vinv is of low level, the through FET Q1 and the shunt FET Q4 are on and the through FET Q2 and the shunt FET Q3 are off. In this state, the path between the terminals TX and ANT is conductive while the path between the terminals ANT and RX is cut off; thus, the SPDT 1 is in the transmission mode. On the other hand, when the control signal Vcon is of low level and the inverse signal Vinv is of high level, the through FET Q1 and the shunt FET Q4 are off and the through FET Q2 and the shunt FET Q3 are on. In this state, the path between the terminals TX and ANT is cut off while the path between the terminals ANT and RX is conductive; thus, the SPDT 1 is in the reception mode.

The shunt FET Q3 is provided to increase the isolation between the terminals TX and ANT, when the path therebetween is cut off. More specifically, the shunt FET Q3 functions as follows. Even when the through FET Q1 is off, the reception signal may leak to the terminal TX via the through FET Q1. In this case, the shunt FET Q3 functions to escape the leaked reception signal to the terminal VD, which lets a high-frequency signal flow to the ground. Likewise, the shunt FET Q4 is provided to increase the isolation between the terminals RX and ANT, when the path therebetween is cut off. The SPDT switch 1 having the shunt FET is called a shunt-type SPDT switch.

An operation of the logical inversion circuit 3 will be described. FIG. 3 is a diagram showing the input/output characteristic of the logical inversion circuit 3. In this embodiment, the resistor R6 has a resistance of 3.1 kΩ and the resistor R7 has a resistance of 2.9 kΩ. As shown in FIG. 3, when the control signal Vcon is of 0 V, the logical inversion circuit 3 outputs an inverse signal Vinv of 3 V. When the control signal Vcon is of 3 V, the logical inversion circuit 3 outputs an inverse signal Vinv of 1.7 V.

Owing to the use of the SCFL circuit as the differential circuit 6, even if the threshold voltage Vth of the FETs is negative, the high level of the output from the logical inversion circuit 3 is 3 V, which is equal to the power supply voltage Vdd. If the high level of the output from the logical inversion circuit 3 becomes lower than the power supply voltage Vdd, the ON resistance Ron of the FET, which receives the high-level signal, will be increased. In this case, the characteristic of the SPDT switch 1 in the transmission mode will deteriorate.

In contrast, according to this embodiment, since the logical inversion circuit 3 keeps the high level at the power supply voltage Vdd, the problem of the characteristic deterioration does not occur. It is preferable that the high level of the output from the logical inversion circuit 3 is the same as the power supply voltage Vdd. However, even if the high level voltage is lower, the effect of this embodiment can be obtained without any problem as far as the reduction is limited within the allowable range of the ON resistance of the FET (for example, about 10% of the power supply voltage Vdd).

The low level voltage of the inverse signal Vinv which is output from the logical inversion circuit 3 is of 1.7 V, not 0V that is normally considered an ideal value. However, the output of the logical inversion circuit 3 is connected via a high resistance to the gate electrode of the through FET Q1, which is turned off in the reception mode. An explanation for this matter will be given below.

First, conditions for turning off the FETs forming the SPDT switch 1 will be described. The power supply voltage Vdd is applied to the source or drain electrode of each FET. Therefore, if the gate voltage is “Vdd+Vth” or lower, the EFT will be off: that is, in the case where Vdd is 3 V and Vth is −0.6 V, if the voltage of 2.4 V is applied to the gate, the FET will be off. Actually, however, in an SPDT switch for handling a high-frequency signal, the high-frequency signal is superposed on the gate voltage. Therefore, to keep the FET off in this case, the DC bias voltage to be applied to the gate is set to a lower value.

However, in an SPDT switch for switching between transmission and reception of a high-frequency signal, the power of the high-frequency signal input through the antenna and output from the RX terminal is feeble and the voltage amplitude is very small. Therefore, if the gate voltage applied to the through FET Q1 and the shunt FET Q4, which are to be off in the reception mode, is slightly lower than “Vdd+Vth”, the through FET Q1 and the shunt FET Q4 can be fully turned off.

In this embodiment, since the low-level signal input to the logical inversion circuit 3 is of 1.7 V, there is a sufficient margin in the gate voltage to turn off the through FET Q1 and the shunt FET Q4. Thus, the reception signal is prevented from leaking to the terminal TX in the reception mode.

On the other hand, since the power of the transmission signal is large, it is necessary to completely off the through FET Q2 in the transmission mode. In other words, the gate voltage to be applied to turn off the through FET Q2 must have a larger margin. In this embodiment, the control signal Vcon is directly supplied to the gate electrodes of the through FET Q2 and the shunt FET Q3. Therefore, it is possible to apply voltage of 0 V to the gate electrodes of the through FET Q2 and the shunt FET Q3 in the transmission mode. Thus, the transmission signal is prevented from leaking to the terminal RX in the transmission mode.

As described above in detail, the SPDT switch 1 of this embodiment has the logical inversion circuit 3 for performing logical inversion of the control signal Vcon that switches between the transmission and the reception. The output signal of the logical inversion circuit 3 is supplied to the gate electrodes of the reception side through FET Q2 and the reception side shunt FET Q4 via high resistances. The logical inversion circuit 3 is formed of the SCFL circuit, and the high level of the output from the logical inversion circuit 3 is substantially the same as the power supply voltage Vdd. Further, the FETs forming the logical inversion circuit 3 have the same structure as the FETs forming the switch circuit 2.

With the structure described above, according to this embodiment, although one control signal is used to switch between the transmission and the reception, the transmission mode and the reception mode can be reliably switched.

Further, in both the transmission mode and the reception mode, necessary high-level and low-level potential can be supplied to the switch circuit 2. Therefore, no signal leaks when a high-frequency signal is transmitted or received.

Furthermore, since the logical inversion circuit 3 is formed of the SCFL circuit, the SPDT switch 1 can be made of FETs of the same structure. Moreover, the FETs of the SPDT switch 1 can be formed on the same substrate. As a result, the manufacturing cost and the circuit area can be reduces.

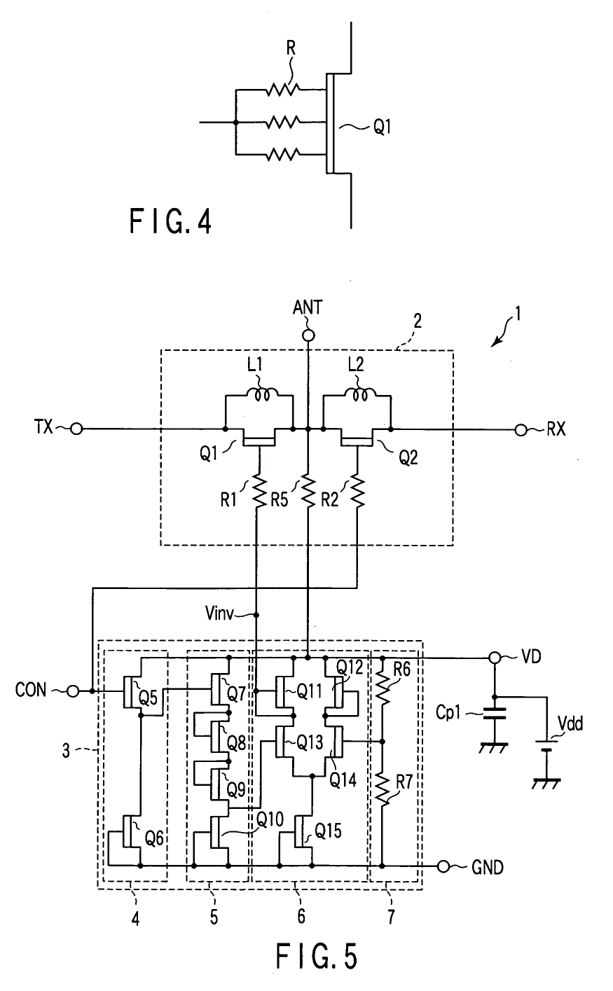

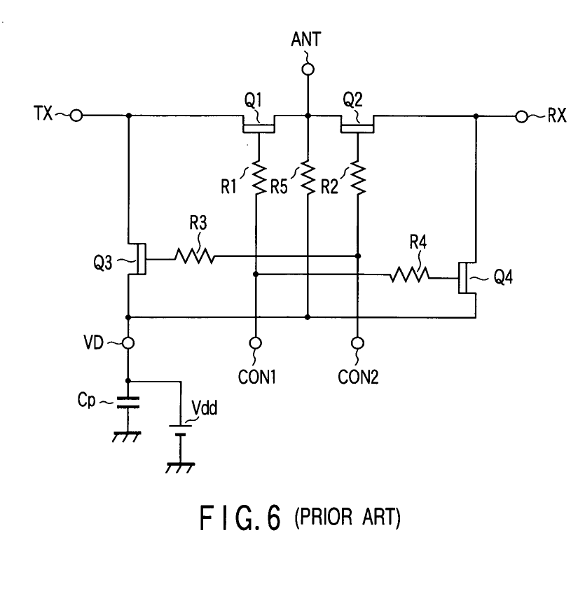

Although the four FETs Q1, Q2, Q3 and Q4 shown in FIG. 1 are single gate FETs, they may be multi-gate FETs. FIG. 4 is a circuit diagram showing an example of the configuration of a triple gate FET. The triple gate FET has a long gate width (length of the gate electrode in the channel width direction) and three wires connected to the gate electrode. A resistor R is connected to each of the wires. If the multi-gate FETs are used in the switch circuit 2, the withstand voltage of the switch circuit 2 can be increased.

Further, each FET may be formed of a MESFET (metal semiconductor field effect transistor) instead of the HEMT to construct the SPDT switch 1 of this embodiment and obtain the same effect. The switch circuit of this embodiment is feasible, when depletion-type FETs in general are used.

### Second Embodiment

In the second embodiment, to construct the SPDT switch 1, inductors are used instead of the shunt FET Q3 and Q4 shown in FIG. 1, so that the isolation between the terminals TX and ANT or between the terminals RX and ANT can be improved.

FIG. 5 is a circuit diagram showing the structure of an SPDT switch 1 according to a second embodiment of the present invention.

The source electrode of the through FET Q1 is connected to one terminal of an inductor L1. The drain electrode of the through FET Q1 is connected to the other terminal of the inductor L1. In other words, the inductor L1 is connected in parallel to the through FET Q1.

The source electrode of the through FET Q2 is connected to one terminal of an inductor L2. The drain electrode of the through FET Q2 is connected to the other terminal of the inductor L2. In other words, the inductor L2 is connected in parallel to the through FET Q2.

When the through FET Q1 is off, the through FET Q1 and the inductor L1 resonate in parallel at a desired frequency. As a result, although there is no shunt FET Q3, the isolation between the terminals TX and ANT can be improved when the path therebetween is cut off. The same can be said of the FET Q2. The SPDT switch 1 having the inductors each arranged in parallel with the FET as described above is called a resonance-type SPDT switch.

The other configuration of the switch circuit 2 and the configuration of the logical inversion circuit 3 are the same as those in the first embodiment.

In the SPDT switch 1 of the above structure, although one control signal is used to switch between the transmission and the reception, the transmission mode and the reception mode can be reliably switched.

Further, in both the transmission mode and the reception mode, necessary high-level and low-level potential can be supplied to the switch circuit 2. Therefore, no signal leaks when a high-frequency signal is transmitted or received.

Furthermore, since the logical inversion circuit 3 is formed of an SCFL circuit, the SPDT switch 1 can be made of FETs of the same structure. Moreover, the FETs of the SPDT switch can be formed on the same substrate. As a result, the manufacturing cost and the circuit area can be reduces.

Although the two FETs Q1 and Q2 shown in FIG. 5 are single gate FETs, they may be multi-gate FETs. Further, each FET may be formed of a MESFET instead of the HEMT, in which case the same effect can be obtained.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A high-frequency switch apparatus comprising:
a switch circuit which switches between a transmission mode of inputting and outputting a transmission signal and a reception mode of inputting and outputting a reception signal, the switch circuit having: a first terminal which receives the transmission signal; a first FET (field effect transistor) which has a first threshold voltage and makes a path of the transmission signal conductive or cut off; a second terminal which outputs the reception signal; and a second FET which makes a path of the reception signal conductive or cut off;
a third terminal which is connected to a gate electrode of the second FET, and receives a control signal that switches between the transmission mode and the reception mode; and
a logical inversion circuit which outputs a first voltage substantially equal to a high level of the control signal in the transmission mode and a second voltage which makes the first FET off in the reception mode, the logical inversion circuit comprising: a differential circuit; an input section which is connected to the third terminal; and an output section which is connected to a gate electrode of the first FET, the differential circuit including third and fourth FETs which have a threshold voltage substantially equal to the first threshold voltage, source electrodes of the third and fourth FETs being connected to each other.

2. The high-frequency switch apparatus according to claim 1, wherein the logical inversion circuit further comprises a level shift circuit which is connected between the third terminal and the differential circuit and level-shifts the control signal in order to make the first voltage substantially equal to the high level of the control signal.

3. The high-frequency switch apparatus according to claim 1, wherein the logical inversion circuit further comprises a voltage generating circuit which generates a reference voltage to be input to the differential circuit in order to make the first voltage substantially equal to the high level of the control signal.

4. The high-frequency switch apparatus according to claim 1, wherein the logical inversion circuit further comprises an input buffer which prevents a current from flowing in through the third terminal.

5. The high-frequency switch apparatus according to claim 2, wherein the level shift circuit includes: a source follower circuit having an FET; and an FET which level-shifts a voltage of the control signal to a negative side and has gate and drain electrodes connected to each other.

6. The high-frequency switch apparatus according to claim 4, wherein the input buffer includes a source follower circuit.

7. The high-frequency switch apparatus according to claim 1, wherein each of the FETs is formed of a HEMT (high electron mobility transistor).

8. The high-frequency switch apparatus according to claim 1, wherein each of the FETs is formed of a MESFET (metal semiconductor field effect transistor).

9. The high-frequency switch apparatus according to claim 1, wherein each of the FETs has a negative threshold voltage.

10. The high-frequency switch apparatus according to claim 1, further comprising a ground terminal grounded via a capacitor, and wherein the switch circuit further comprises: a fifth FET which is connected in series between the first terminal and the ground terminal and which has a gate electrode connected to the third terminal; and a sixth FET which is connected in series between the second terminal and the ground terminal and which has a gate electrode connected to the output section of the logical inversion circuit.

11. The high-frequency switch apparatus according to claim 1, wherein the switch circuit further comprises a first inductor connected in parallel between source and drain electrodes of the first FET and a second inductor connected in parallel between source and drain electrodes of the second FET.

12. The high-frequency switch apparatus according to claim 5, wherein the FETs forming the level shift circuit have a threshold voltage substantially equal to the first threshold voltage.

13. The high-frequency switch apparatus according to claim 3, wherein the voltage generating circuit further comprises an input section to which a power source voltage is input, two resistors connected to the input section in series and an output section connected between the two resistors.

14. The high-frequency switch apparatus according to claim 6, wherein the input buffer is formed of an FET having a threshold voltage substantially equal to the first threshold voltage.

15. The high-frequency switch apparatus according to claim 1, wherein the switch circuit and the logical inversion circuit are formed on one substrate.
